(19) United States
(12) Patent Application Publication
(10) Pub. No.: US 2016/0061618 A1
(43) Pub. Date: Mar. 3, 2016

(54) TECHNIQUE FOR NAVIGATING A VEHICLE TO A PARKING PLACE

(71) Applicant: PARKLIFE LTD., Tel Aviv (IL)

(72) Inventors: Itzhak Benenson, Tel Aviv (IL); Nadav Levy, Tel Aviv (IL)

(21) Appl. No.: 14/836,623

(22) Filed: Aug. 26, 2015

(30) Foreign Application Priority Data
Aug. 27, 2014 (IL) 234323

(51) Int. Cl. G01C 21/36

(52) U.S. Cl. CPC G01C 21/36

(57) ABSTRACT

A technique for providing to a user, while driving and seeking a parking place in a parking area, a continuously extending best parking route which ensures the maximal number of expected curb parking places and satisfies a set of parking preferences of the user. Simultaneously, one or more additional parking routes may be provided to the user.

### CROSS-REFERENCE TO RELATED APPLICATION

This application claims priority to Israeli Patent Application 234,328, filed on Aug. 27, 2014, the disclosure of which is incorporated herein by reference in its entirety.

### FIELD OF THE INVENTION

The present invention relates to the field of decision support tools, and, more particularly, to the field of decision support tools for drivers. More specifically, the present invention belongs to the field of computerized navigation of land vehicles, namely to a technique for navigating a vehicle to a parking place which would be located in close proximity to a pre-selected destination.

### BACKGROUND OF THE INVENTION

A driver of a vehicle, who wishes to visit a destination, must locate a parking place (PP) within the area of the destination, at which to park the vehicle during the visit. Various types of PP may be available, including free and paid curb PP, PP at the public or private garages or at non-organized open spaces.

PP may be available to all drivers or restricted to the drivers/vehicles of specific types, depending on the type of the drivers (e.g., resident or visitor of the area, private or commercial car). Parking limitations for each category of drivers and cars can vary during time of the day, day of the week and month of the year.

PP may differ in their size and fitness to the dimensions and type of the car and accessibility by foot (steps, inaccessible for disabled persons, etc.).

There are a number of prior art references, which describe various techniques for navigating a vehicle to an entrance of the parking lot, to a PP in the parking lot or to a known vacant curb PP located close to a known destination. This is usually implemented by utilizing OPS services provided to phones, laptops etc.

Most of the prior art references define location of the parking lot or PP as being in a walking distance from the destination, for example U.S. 2010/0042318 A1.

Some references describe or discuss ways of selecting a suitable parking place among available private parking lots and free parking places. One example of such solutions is described in U.S. 2009/0171567 A1.

There is also a group of references which disclose methods of searching free parking spaces according to probability that the PP will be vacant, for example according to frequency of finding them vacant in the past, or according to estimated duration of a search for specific parking spot(s). Such a group comprises JP 2010-223797 A, U.S. 2014/0340242 A1, U.S. 2012/0161984 A1.

The prior art also comprises solutions which propose ways of exchanging information about free parking places between drivers located in the same area, for example by using various social networks like in U.S. 2010/0302068 A1.

### OBJECT AND SUMMARY OF THE INVENTION

The present inventors have recognized that the drivers that cruise for parking, in some instances, do not know which curb parking places are occupied and which are free at a given moment of time. Different from the parking lots, there are no standard sources of information about the curb parking occupancy. Even if the exact location of the free curb PPs is known, they can be occupied a few moments later by other drivers who search for a parking place in the same area. In this circumstances, especially when the number of drivers who cruise for parking is close to or even higher than the instantaneous number of the parking places (PP) that are available for the parking in the area of search, the time of the parking search is very uncertain, and, averagely, very high. Given a limited search time, a chance of failure in finding a PP that satisfies driver's preferences is also high. The drivers that cruise for parking focus on recognizing vacant PP and parking lots, and are thus inattentive to the road situation. In addition, cruising cars drive at a speed that is lower than the speed of commuting cars and disturb general traffic. The lower, comparing to the general traffic, speed of the cruising drivers, and their inattention to traffic conditions causes traffic congestion, excessive fuel consumption, air pollution and traffic accidents.

It is therefore the object of the present invention to propose a novel technique of providing guidance to a driver, which would overcome the above-mentioned drawbacks and would flexibly and/or effectively assist the driver to find a vacant parking place suitable for the driver in any current specific situation. In particular instances, one or more additional parking routes may be provided to the user, for example: an alternative best parking route satisfying an alternative set of parking preferences, a route to a parking lot being closest to the user's destination; a route to a cheapest parking lot in the parking area, and/or a route to a parking lot arbitrarily chosen by the user.

The following terms and definitions will be used in the present patent description and claims.
the term “user” may be used in parallel with the following synonyms: driver, passenger, client; all such terms define a person making use of the inventive technique for finding a parking place in an urban area;
the term “route” may be used in parallel with the term “path” for defining a trajectory/way of a user's vehicle movement in an urban area. A route is composed from portions, while a portion is composed from segments. Both portions and segments are parts of a route.
the term “portion” may be used in parallel with the terms “ portion of a route” “route portion” “piece of a route” and indicates a part of the route including at least one but usually more street/road segments ; in the present invention, each road segment is understood as a road section/link between two adjacent junctions, and is characterized by a particular number of parking places and “expected number of vacant curb parking places” (ENVP); the ENVP may vary depending on season, weekday, hour, etc.

In the frame of the invention, “portions” are pieces of a route that is constructed/calculated by the proposed technique. Typically, route portions may have length of 300-500m, while segments, in urban area may have typical lengths of about 50-150 m.
the term “best parking route” may be used in parallel with the following synonyms: “optimized parking route/path”, “best/optimized parking search route/path”, “best /optimized route/path” and the like, wherein all of the synonyms are intended to describe the way calculated by the inventive system for a driver to maximally assist the driver to find a suitable parking place in a specific parking area.
the term “combination of parking preferences” may be used in parallel with the following synonyms: “a set of parking preferences”, “a set of parking permits/privileges and preferences”, “a set of parking criteria”, and is associated with one or more parking conditions formulated by a specific user (driver/client/passenger) before starting the parking search.
the term “curb parking place” may be used in parallel with the following synonyms: “on-street parking place”, “street parking place”, wherein all the terms indicate parking places (PP) along streets, being either free of charge, or associated with relatively modest rates. The present description discusses searching for a vacant parking place, which is preferably a curb parking place. Therefore, any parking search (physical or computerized) in the frame of the present description should be understood as a search for vacant parking places.
the term “parking lot” may be used in parallel with the following synonyms: “off-street parking place”, “garage” and indicate parking areas and facilities characterized by relatively high rates;
the term “Server Database” may be used in parallel with terms “Server-based parking search Database”, “main Database” and the like; said Database should be understood as a centralized Server Database, which accumulates information on parking availability in an urban area and allows performing therein parking searches for a plurality of users.
the term “User Database” may be used in parallel with the term “User-specific parking search Database”, “User Specific Database” and the like; the User Database is built using the main Database and allows performing therein parking searches for a specific user.

The concept of the invention comprises the following three principles of navigation, (i.e. providing guidance to a user in a vehicle) while seeking for a vacant parking place, both separately and in combination with one another.

The first principle comprises providing to a user, while driving and seeking for a parking place, an endless best parking route “wandering” within a parking area determined around the user's destination,
by calculating and presenting to the user portions of said best parking route one by one, in real time, thereby gradually lengthening said best parking route,
wherein each newly presented portion of the best parking route,
is calculated based on the user's current location and based on information about parking availability within the parking area;
is characterized by a maximal, among all possible portions, ENVP - number of vacant curb parking places expected on that portion according to said information;
satisfies a set of parking preferences stated by the user,
the method thereby ensures the maximal ENVP—expected number of the vacant curb parking places—along the best parking route that always remains within the parking area up to a moment, when either the user finds a vacant curb parking place that satisfies the set of user's parking preferences, or the parking preferences are changed. (The latter case may also include a situation when the driver cancels the search for curb parking and drives for parking to a parking lot—see below).

According to the above principle, the theoretically endless best parking route is calculated by portions (road portions). In urban areas, the proposed route portions may have lengths of about 300-500 m. Such route portions are built from road segments which may have a typical length of 50-150 m in urban areas.

Information about parking availability per road segment may be stored in a suitable Database, and may be represented as a number of expected vacant curb parking places PP on a segment. How to create, use and update such a Database of parking availability, will be described later in the description and illustrated in the drawings.

Though the above-mentioned number is a statistically expected number for a road segment, for a longer that segment portion of a route, such numbers allow sufficiently accurate prediction of the expected number of vacant parking places along a said road portion and further along the best parking route, when the road portion (and the best parking route) are sufficiently long. The present inventors have realized that if the actual number of vacant PP on one segment of a portion can be lower/higher than expected, the error will be compensated by the opposite deviation on next segments.

It has been noted by the present inventors, that the more segments are incorporated in a route portion while calculating it, the more accurate prediction can be made about the probability to find such vacant parking places along the unit length (say, 100 m) of that portion. It is therefore supposed that a portion of the best parking route preferably comprises two or more road segments.

Additionally, the mentioned information and further - all road segments within the user's search area may be instantaneously updated regarding the ENVP (number of expected vacant parking places), for example by using data received from the user and from other users driving in the parking area. Such data may be obtained from time to time, periodically or continuously, in real time.

The second principle comprises providing to a user, while driving and seeking for a parking place in a parking area determined around the user's destination, a best parking route within the parking area, ensuring the maximal ENVP (number of expected curb parking places) there-along and satisfying a set of parking preferences of the user, and simultaneously one or more additional parking routes comprising at least one of the following:
an alternative best parking route(s) satisfying an alternative set(s) of parking preferences of the user;
a parking route, to a parking lot being closest to the user's destination;
a parking route to a cheapest parking lot in the parking area or beyond it, according to the user's preferences;
a parking route to another parking lot, arbitrarily chosen by the user in the parking area or beyond it.

The best parking route may be built according to the first principle described above.

The parking routes to any of the mentioned parking lots may additionally be optimized to comprise the maximal possible number of expected vacant curb parking places there-along. For example, such a route to any of said parking lots may be optimized so that:
it comprises maximal ENVP (expected number of the vacant PP), and
the difference between the optimized parking route's length/driving time and that of the shortest/fastest route to the lot is limited by a pre-established value.

According to the present inventors' estimates, the proposed pre-established value may be selected as 10% to 100% of the shortest/fastest route to the parking lot.

For example, the optimized path to a lot may be not more than 50% longer than the shortest path to the lot.

In some embodiments, several provided said parking routes may be simultaneously presented on a display of the user's mobile device in a manner allowing the user to clearly distinguish between them. Depending on expected availability of the vacant PP on the presented portions of the routes and depending on other considerations, the user may change the parking preferences and choose between several optimized curb routes and the routes to the off-street parking places.

The third principle comprises a manner of determining a route portion for a user while driving and seeking for a parking place in a parking area determined around the user's destination, by determining all possible route portions within the parking area, starting from the user's vehicle current location (CL) and being not longer than a predetermined length, selecting from said possible route portions a route portion satisfying a set of parking preferences of the user and characterized by the maximal number of expected vacant curb parking places (ENVP), and presenting the selected route portion to the user. In case the user's vehicle has not parked on the curb of the selected route portion, and has approached the final junction of the last segment of the route portion, a next route portion that starts at that final junction may be calculated. The next route may be calculated well in advance for the expected new CL (being the final junction of the previous route portion) and be timely presented to the user, thereby forming a gradually extendable, theoretically endless best parking route.

This third principle may be used for constructing (i.e., calculating) and presenting portions of the best parking route according to the first principle.

By using one or more of the above principles, the following improved, new technique may be provided.

It could be a technique (i.e., a method, a system, a software product) for enabling navigation of a user's vehicle to find a curb parking place close to a user's destination, via an instantaneously updated and gradually lengthening best parking route within a parking area (i.e., always located within a predetermined distance/time of walking from the destination), wherein the best parking route is calculated from a current location of the user's vehicle, and, during the navigation there-along in real time, ensures maximal possible, among all possible parking search routes, probability for the user to find a vacant curb parking place that fits to a set/combination of parking preferences selected by the user. The calculation may be performed as mentioned above. The mentioned probability to find a vacant curb parking place may be ensured and maximized by instantaneous updating of the information about parking availability in the parking area. In case the user decides to cancel the above-described curb parking search and to park at one of the parking lots, the technique should be capable to provide the route to such parking lot and preferably to guarantee the highest, among all paths leading to the lot, probability to find a curb parking place yet on the way to the lot.

The best or optimal parking route may be defined as a route for which the expected number of vacant curb parking places along each portion is maximal among all portions of the same or shorter length within the mentioned parking area and start at the same location being the user's vehicle current location, wherein, for example, the expected total search time along the best parking route is below a threshold selected by the user. Such a threshold may be the only condition in the user's set of parking preferences.

Generally, the method should ensure performing the navigation towards the user's destination until the parking area is reached; however, when the user's vehicle is already within the mentioned parking area, the method comprises performing the navigation within the parking area along the routes that provide the highest probability to find a vacant curb parking place, so that the user's vehicle may sometimes be navigated away from the user's destination.

The method is thereby characterized by providing the optimized route for cruising for the curb parking in the farm of an endless, continuously extending path/route “wandering” around the destination within the parking area, that comprises a possibility that the user's parking preferences and/or parking availability may change during the search, up to termination of the route either by parking of the user's vehicle, or by cancelling the curb search and choosing to drive for parking to the cheapest/closest/arbitrarily selected parking lot.

The above-mentioned “optimal/best curb parking search route”, that “wanders” around the user's destination, may be created by repeatedly presenting to the driver an additional portion of the best/optimized parking route as continuing already presented portions, for example each time when a previously presented portion thereof was half-passed and a vacant parking place was not yet found. The additional portion(s) of search route(s) are calculated with a sufficient lead that allows presenting them at the indicated moment.

Any navigation technique usually requires input values being the user's destination DEST and the user's vehicle current location CL.

The proposed technique needs also a set of user's parking preferences which include user's personal characteristics/permits and user's parking conditions, which may comprise for example the following privileges and limitations:

User's characteristics:
resident/visitor of the city,
relevant parking permits (for example, permits of taxi drivers, emergency vehicles, working/trading vehicles at specified areas, etc)
conventional driver/handicapped driver entitled for special parking places;
type of the vehicle (for example, private car/van/truck/bus etc. parking conditions:
maximal walking distance/ time from the parking place to the destination, which parameter defines the borders of the parking area around the destination DEST;
maximal price of the curb/off street parking place (according to the user's willingness to pay);
maximal search time available to the driver for searching the parking place;
latest time of arriving to the destination's entrance, etc.

Usually, default values exist for any of users' characteristics and parking conditions, in case they are not selected by the specific user.

Different users usually have different parking search preferences, e.g. to remain close to the destination during the entire period of cruising, or to cruise, along the streets where parking is free of charge.

The proposed new technique may be adapted to build and update the best parking routes for arbitrary combinations of users parking preferences, and is capable to present to the user those of the routes that are relevant for him/her.

As mentioned, two or more different parking routes may be simultaneously presented (displayed) to the user.

For example, the different parking routes and their parts may be displayed using different colors or patterns, so that the user may easily distinguish them.

Any of the discussed parking routes may indicate an expected number of vacant parking places (ENVP) along said route, for example by segments.

Portions of the routes and route segments having different expected number of the vacant PP may have different colors, patterns or symbols.

Parking restrictions of the road segment being currently ahead of the user may be reported to the user (for example, by displaying preliminarily agreed indications, for each side of the curb, on the user's mobile device).

If two or more said parking routes are presented to the driver, these routes may sometimes coincide at least partially. Then the user has to choose one of them when they split, and it is usually done just factually, by driving the vehicle along the selected route.

However, if the driver does not follow any of the proposed routes, the system is supposed to recalculate the routes according to the new CL of the vehicle and previously selected parking preferences.

As mentioned above, the two or more parking routes may comprise two different best parking routes which optimize the probability to find a curb parking place, but according to different pre-selected combinations of the parking preferences.

Alternatively or in addition, these two or more parking routes may comprise said best parking route and one or more additional routes which, for example, are built for navigating the vehicle to a parking lot being a) the closest to the destination, or b) the cheapest one within the parking area or, if the parking area does not contain parking lots, to the cheapest or closest or selected by the user lots that are beyond the parking area. Also, the user may order an additional parking route to a parking lot which is c) known in advance/usually visited/etc.

As mentioned, the routes to the parking lots may comprise optimizing thereof to maximize the probability to find a curb parking place on the way to the parking lot. Such hybrid navigation may be selected by the driver and may also depend on a selected set of parking preferences.

In some embodiments, any parking availability information for the parking lots and/or for street parking, including statistical and real-time information that can be obtained is taken into account, when calculating the portions of the parking search routes.

The real time updates can be provided for example as follows. When the user's vehicle navigates via a specific road segment (say, close to the user's destination and suggested by the technique for parking there), but does not park there and continues the search, then an automatic update is triggered and the instantaneous estimate of the expected number of vacant parking places on that segment is decreased or set equal to zero.

As mentioned above, the best parking route is instantaneously extended during the driving, thus providing continuous guidance of the driver during cruising of the driver's vehicle for allocating a vacant parking place (PP) within the specified parking area around the driver's destination.

By default, the proposed best parking route is an endless route (since it does not have a specific destination), that satisfies user's parking preferences which can be changed during the search. As discussed, a specific optimized parking route may be terminated when the driver finds a parking place (PP), or when the driver's decides to change the set of preferences or just to cancel the search and park on the parking lot.

The latter may happen, for example, when the time budget goes to expire, so the driver (or the system) may cancel the best parking route and select a spare (additional) route parking which will navigate the user's vehicle to a paid parking lot close to the destination. Other examples may be found.

The technique may instantaneously estimate, for each of the proposed best parking routes one or more of the following expected parameters: search time, total parking fees, maximal distance between the expected parking place and destination, maximal walk time between the expected parking place and the destination, a probability to fail to find a parking place during a predetermined search time.

The method may additionally prevent navigating of two vehicles along the same best parking route, one user shortly after the other, thus decreasing the probability to park for the follow up vehicle.

In cases when too many vehicles simultaneously look for parking places in the same parking area or in the overlapping parking areas, the method may provide dividing the users' vehicles into several (at least two) groups and navigating vehicles of different groups according to different policies. For example, the users may be divided depending on the maximal total search time they indicated, and then the users with the expiring time limit may be navigated to the routes with the highest probability to park or to the parking lots (in case the highest probability to park is yet low). Those users who indicated longer maximal search time may be navigated along the routes where the expectation to find a curb parking, during a longer search time, is sufficiently high.

According to a second aspect of the invention, a system is provided for implementing the above-described method.

It may be defined as a system for providing guidance to a user driving a user's vehicle and seeking for a vacant parking place in a parking area selected around the user's destination DEST, which system may comprise:
a Server;
a Server Database DB for storing information on availability of vacant parking places in an urban area comprising said parking area, and for determining parking routes in the urban area, the DB being in real time communication with the Server or being a part of the Server;
a mobile device located in the user's vehicle, equipped with a GPS sensor and capable of establishing real-time bidirectional communication with the Server, wherein the Server is operative:
   to communicate with said mobile device for receiving therefrom information on the user's destination DEST, user's vehicle current location CL, a set of the user's parking preferences;
   to communicate with the mobile device for providing it with a best parking route, determined using said DB, according to said set of the user's parking preferences and being maximized regarding a number of expected vacant curb parking places there-along.
   to receive updates from said mobile device at least on the user's vehicle current location CL, user's parking preferences and update said DB accordingly.

The Server may be further operative:
to form a User Database, UDB, using said DB and based on the information received from the user including user's destination DEST; said User Database being suitable for determining parking routes in the parking area;
to provide to said mobile device either:
   a best parking route, determined according to said set of the user's parking preferences and being maximized regarding a number of expected vacant curb parking places there-along, calculated by the Server using said User Database, or
   the User Database for calculating said best parking route at the mobile device.

The side (server or user) for calculating the best parking route may be selected by each specific user, depending on configuration and capabilities of the user's mobile device.

In some embodiments, the Server is also adapted
to receive updates from said mobile device on the user's parking search results (e.g., from the start of parking search to the current moment of time, including failures/success to find a vacant parking place on the traversed road segments) and update said DB (and optionally, the relative UDB) accordingly.

In practice, the system comprises a plurality of mobile devices of the plurality of users, and is adapted to support simultaneous communication between the server and the plurality of mobile devices (smartphones, laptops, tablets, etc.).

In the system comprising a plurality of the mobile devices in communication with the Server, the Server is capable to form and provide to said mobile devices respective UDBs, wherein at each of said mobile devices the received UDBs are further processed and filtered to form at least one said best parking route according to the user's set of parking preferences.

As mentioned with reference to the method, said best/optimized parking route is an optimized parking route within the parking area, wherein the parking area is located in a predetermined distance/time of walking from the user's destination; the best/optimized parking route, during the navigation there-along in real time, ensures maximal possible probability for the user to find a vacant parking place PP (more preferably, a curb parking place) according to the set of parking preferences selected by said user.

The Server Database may comprise at least data, preliminarily collected, about streets (squares, etc.) of the urban area, including the estimates of a number of vacant curb parking places (on-street PP) that are usually expected during specific hour of a day and periods of year, season, month, week, daytime, nighttime, working day or the weekend and optionally during special occasions (for example, various public events). The Server Database may also comprise similar information on paid parking lots/garages (off-street PP), and on the curb- and off-street parking places and facilities for special categories of drivers, e.g., handicapped persons. Usually, the Database may also comprise information on parking permissions and facilities for different group of drivers—residents of the city and neighborhood and visitors, as well as on the permissions for parking permissions for the specific groups of drivers (e.g. small business owners or taxies). Database is thus capable of performing navigation (parking) searches for the drivers depending on their individual characteristics, since different drivers have different parking possibilities in the city.

Additionally, the system may forecast parking availability in the area in case of irregular events, as a public meeting or temporarily limitation of the access to the area imposed by the police over the area that overlaps the said parking area or is located nearby thus indirectly influencing parking availability in the parking area.

The information about parking limitations for different group of drivers or about the irregular events can be obtained, for example, from municipality sources.

In one practical version, the initial information in the Database is obtained based on the Open Street Map, field surveys and remote sensing techniques and later enriched with the real-time information obtained from the system users.

As mentioned, in one embodiment of the system, the Server is capable to present the User Databases to the user's mobile devices, wherein at the mobile devices capable of processing, the received databases are further processed and searched to form the best/optimized parking route/s (and other, for example additional routes to parking lots) according to the individual selected combinations of parking preferences.

In another embodiment, the mentioned parking routes may be calculated at the Server, based on the information received from the mobile devices of the users.

Actually, parking routes for a plurality of drivers may be calculated by the proposed technique simultaneously.

The system is operative to select the parking routes that are further presented to different drivers, according to the drivers' location, destination and parking preferences and avoiding the situation when two or more drivers search for parking along similar routes with a small time gap between them.

According to a third aspect of the invention, there is provided a software product (so called facility) for guiding a user during driving and searching for a parking place PP.

The software product designed by the Inventors comprises computer implementable instructions and/or data for carrying out the method (according to any one of its modifications as described herein), stored on an appropriate computer readable storage medium so that the software is capable of enabling operations of said method when used in a computer system.

The proposed software product (facility) forms a more detailed system and may comprise the mentioned Server Database, a central Processing block at the Server and a plurality of mobile software applications (such as a Smartphone Client at the user's mobile devices), with their local processing blocks and interfaces. The interfaces allow communication of the mobile devices with GPS services, the central Processing block and with the user/s.

In some embodiments, the major part of the software product is located on the Server, while each of the mobile software applications adapts and presents the route/s to the driver and instantaneously reports to the Server about the driver's current location.

The software product is capable of communicating and cooperating with a GPS service via the GPS sensors at the user's mobile devices, and of course with the instantaneously updating Database of parking places and their availability in the urban area of interest. The software product may preferably be adapted for real time interconnection and self-updating from various sources of real time information on parking availability. Such sources may be just the mobile devices of drivers using the same system. Such mobile devices, via their software applications, may automatically update the system/Database/software product. Another example of such a source may be a social network providing updates initiated by participating drivers who search for parking places in the same urban area or parking area.

The software product is, in some embodiments, capable of performing tens of thousands parking searches simultaneously. The searches may be performed using the Server Data ease, which is optionally updated by real time information on availability of the parking places in the parking areas of different user.

In the detailed description which follows below, more options and specific details will be presented, which are related both to the method, the system and the software product proposed by the Inventors.

### BRIEF DESCRIPTION OF THE DRAWINGS

The invention will be further described and illustrated with the aid of the following non-limiting drawings in which:

FIG. 1 shows an exemplary block diagram of one embodiment of the system according to the invention.

FIG. 2 schematically illustrates one example of parking routes, as can be calculated and presented by a user's mobile device for navigation according to the invention.

FIG. 3 shows a schematic exemplary flow chart illustrating steps for initialization of the proposed navigation system.

FIG. 4 is a schematic exemplary flow chart illustrating one version of navigation of a user's vehicle by the proposed system.

FIG. 5 is a schematic exemplary flow chart illustrating one possibility of updating the data base of the system about real time parking availability in the area of interest.

FIG. 6 is a schematic exemplary flow chart illustrating a version of calculating an optimized parking route for a user's vehicle.

### DETAILED DESCRIPTION OF EMBODIMENTS

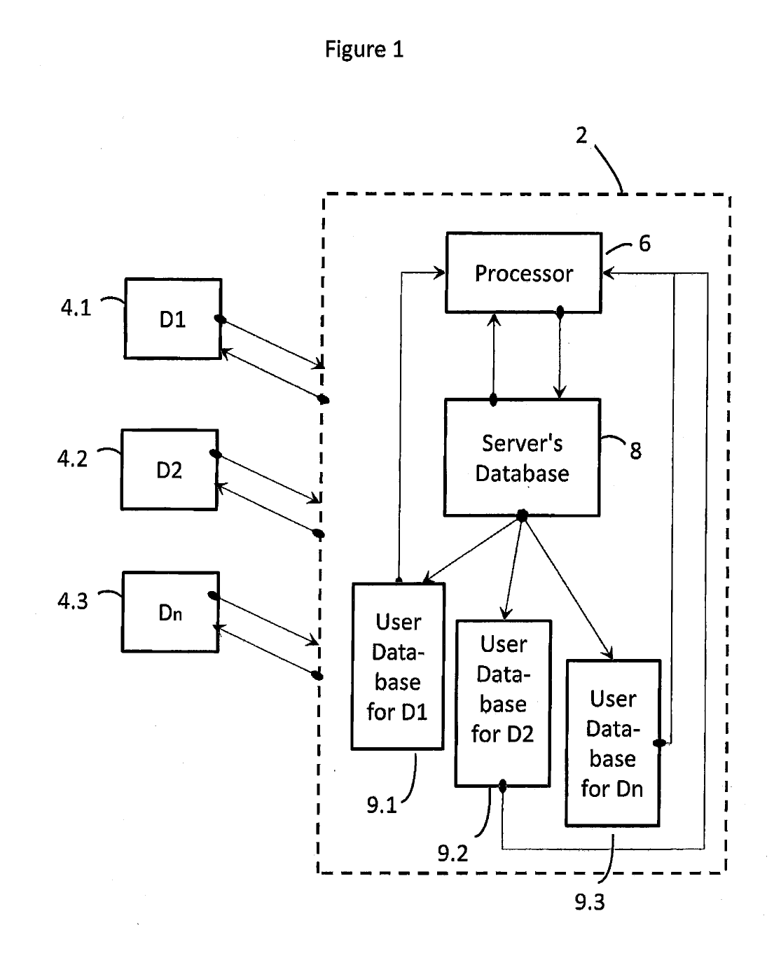

FIG. 1 shows a simplified block-diagram of one embodiment of the system according to the invention. The system comprises a Server (S) marked 2 and a number of clients/drivers (D1, D2, . . . , Dn) being in bidirectional communication with the Server.

The system is intended for assisting drivers to find parking places in a specific urban area. The clients are respectively represented by their mobile devices marked 4.1, 4.2 . . . 4.n. The Server comprises a Server's Processor 6 being in bidirectional communication with a Server's Database 8 (main Database) which comprises data concerning the urban street network and parking lots—network topology, curb parking permissions, lots capacity, parking prices, etc., and also concerning the parking availability on specific streets/street portions in the area depending on seasons, months, working days or holidays, hour, etc. The main Server Database is suitable for performing parking searches. Upon performing parking searches in the Server Database 8 for specific clients, User Databases are formed by the server and also stored. Each of the specific (User) Databases is intended for a specific client. In FIG. 1, such User Databases are shown as blocks 9.1, 9.2 . . . 9.n being in communication with the main Server Database 8, for updating the specific databases from the main Database 8 (if the latter is updated). The User Databases are also connected to the Server's Processor (or its interface, not shown) for forwarding the User Databases to the respective clients.

The system may work as follows.

Client/driver/passenger (say, D1) determines its current location CL using its mobile device, and transmits it to the Server 2, along with information about the driver's destination DEST and (optionally) with at least one set of D1's parking permissions and preferences. (Let for example, the set comprises a resident's parking permit, and conditions to park the car at a free of charge curb parking place at a maximal distance of 200 m from the DEST, and to fulfill the task within 10 minutes, including the walking time from the parking place up to the DEST).

Server's Processor 6 applies to the main Database 8 a proprietary inventive algorithm for parking search and uses the known DEST of D1 (and optionally the set obtained from D1), and then builds a User Database 9.1 for the client Dl. The User Database 9.1 is stored at the Server 2 or to be then transmitted to the client 4.1. Such a User parking search Database comprises all possible routes around the client's PEST within a parking area which is defined either by a predetermined default or transmitted by the user's permissions and preferences, as 200 m radius around the DEST in the above example.

If any parking permits and preferences of D1 are received at the Server 2, the User Database 9.1 built at the Server may also suggest to the user the portion of at least one best/optimized parking route which satisfies the set of parking permits and preferences of the user D1. If the user's preferences are over-restrictive and none of the search routes satisfies them the user is suggested to weaken the preferences. In a standard case such a route exists and ensures the maximal number of expected curb parking places along its portions taking into account the limitations such as the available time budget, etc. The best parking route is understood as an endless route gradually formed by the portions thereof, wherein the next, after the current, portions are built in real time one after another and are suggested to the driver one by one in case a suitable parking place is not found at the previous current portion.

By default, or taking into account the current situation with curb parking places in the parking area, the Server may also provide the user D1 with portions of additional parking route(s). For example it may be another best/optimized parking route but formed for another set of parking preferences (say, suggesting parking places located farer from the DEST). In another example, the additional route may be a route to the cheapest parking lot in the parking area and/or the closest to the PEST parking lot. Such a route may further be optimized to ensure maximal expected curb parking places along the proposed way to the parking lot The proposed route(s) are suggested to the client D1 and displayed on the screen of the client's mobile device 4.1.

The client 4.1 drives according to a route selected by him/her from the routes proposed by the Server 2, the client's current location is regularly transmitted to the Server as well as the fact of parking/not parking the car. Server 2 collects the client's locations and the facts of parking/not parking, and decides whether the client's User Database (and the main Server Database 8) should be updated about the current status of parking availability at specific streets of the urban area.

It should be noted that the client D1 may select not to transmit to the Server its parking permits/preferences; in this case the client D1 may use the User Database 9.1 received from the Server for performing the parking search at the client's mobile device, and for determining the optimized parking route(s) locally (if the mobile device is capable of performing such processing). In the embodiment shown in FIG. 1, all the clients inform Server about their current locations and the status of parking along the street segments that they traverse and the Server Database is immediately updated to accommodate the new information. If the Server decides that the User Database(s) should be updated, it updates one or more User Databases (9.1, 9.2 . . . 9.n) stored at the Server 2. Specific updates may be then transmitted to one or more suitable clients (4.1, 4.2 . . . 4.n).

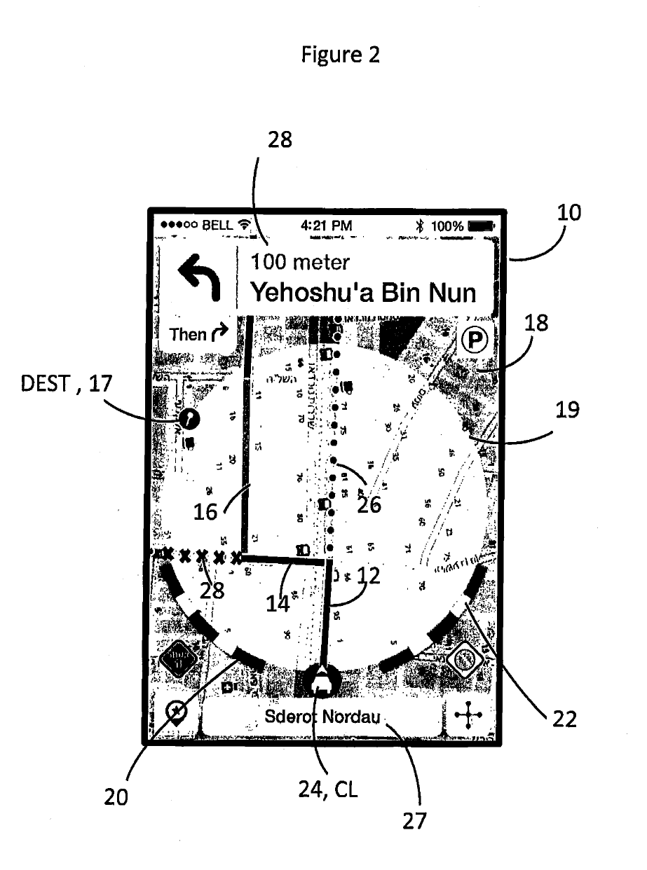

FIG. 2 actually shows one exemplary screenshot from display 10 of a user's (driver or passenger) mobile device, during the use of the proposed inventive facility. The screenshot will be used to explain the invention in more details.

Each user of the proposed system, seeking for a parking place PP around a predetermined destination, submits to the system: a) user destination DEST and b) at least one combination/set of user's parking preferences which indicate b1) whether the user has any privileges in the parking area (as resident of the area, handicapped person or the owner of special parking permission in the area), and b2) personal parking preferences defining, for example: the maximal walk distance from expected parking place PP to the destination DEST, the maximal PP price (willingness to pay), the maximal total parking search time, etc.

Each specific combination of such and/or other possible entries constitutes a set of a user's parking preferences. Each user may create more than one such sets of parking preferences and may further compare the corresponding recommended parking routes calculated by the system for said preferences' combinations/sets.

In FIG. 2, destination DEST of our exemplary user is marked by 17 and the user searches for parking within of a parking area 18 around DEST (borders of the parking area are not shown in FIG. 2), wherein the radius of the parking area is defined by the user. Our driver's car 24 (which is shown as currently situated at the point CL—current location) searches for parking in the parking area. A smaller circle 19 shown in FIG. 2 corresponds to the zoom along the proposed optimal search route on the user's display. In the example of FIG. 2, the user's destination DEST (17) is seen on the border of circle 19; however, in practice, they usually do not coincide and, at a close zoom, the destination can be beyond the area presented at the mobile device screen.

Given a specific driver's destination and driver's privileges and parking preferences, the proposed technique is able to determine, instantaneously update and present to the driver at least one parking search route instantaneously updating itself in the real time. In FIG. 2, the best (optimized) parking route is shown by three solid road links 12, 14 and 16. The best parking route provides maximal expected number of the vacant parking places that fit to the driver's privileges and preferences.

In some embodiments, the technique also determines, presents and displays to the client at least one additional parking route. Usually, additional parking routes are routes to two parking lots, one being the closest to the destination and one being the cheapest in the parking area or beyond, and such an example will be further discussed with reference to FIG. 2

Alternatively or in addition, the alternative optimized parking route may be formed and presented for an alternative set of the driver's parking preferences.

The mentioned best possible parking search route may be generated based on estimating, for each segment of a road between two junctions like 12, 14, 16, an expected number of vacant

PPs and characteristics of these PPs. Such expected numbers of the parking places may be directly displayed, or may be translated into colors or patterns of the segments 12, 14, 16. For example, red segments indicate that the probability to find a parking place on them is low, while blue links indicate high probability of the vacant parking place.

When a car 24 drives along a specific road segment (segment 12 in FIG. 2), characteristics of parking permissions at the right and at the left sides of the road link may also be displayed. For example, it can be done at the right bottom arc and at the left bottom arc of the driver's zoom circumference, as shown by patterns 20 and 22.

The initial expected number of the vacant parking places for specific street segments is initially estimated by the proposed technique, based on the remote sensing techniques and/or previously performed field surveys which form a parking Database 8 of the entire urban area.

The Database may be later enriched with information that is accumulated from the users or other sources. Based on the characteristics of the vacant curb PPs, the technique/facility constructs each of said “best possible parking routes” so that each of them satisfies a specific set of criteria (i.e., the driver's parking preferences) and guarantees the highest possible expected number of the vacant curb PPs along them.

As has been mentioned above, different sets of preferences result in different best possible parking search routes, e.g., 1) a route that minimizes the expected search time, 2) a route that always remains close to the destination or 3) a route that minimizes curb total parking fees, 4) a route that combines two or more of the above-mentioned criteria giving some weight to each of them, 5) a shortest route to the closest parking lot; 6) a shortest route to the cheapest parking lot, etc.

FIG. 2 illustrates one example according to which, for car 24, the proposed system displays not only the best/optimized parking route comprising links 12-14-16, but also route 26 to the cheapest parking lot in the area 18 (route 26 is marked with dots), and route 28 to the lot that is the closest to destination DEST (route 28 is marked with crosses).

Routes 26, 28 may be just the shortest paths to the lots, but may be optimized by the proposed method to provide the highest possible probability of the curb parking on the way to these lots in order to nonetheless avoid off-street parking with its relatively high fees, also by taking into account the driver's preferences, as a total search time available.

In another example, an additional best parking route corresponding to another set of the driver's parking preferences may be a route which suggests navigation within the same parking area but with a lowest curb PP price (or with a lower time limit, always remaining closer to the destination, etc.)

In some embodiments, the user's mobile device displays portions of the route/s that is/are presented, several next links of each of the discussed best search paths, and guides the driver turn by turn.

The zoom area 18 on the display may also provide indication of the current street the user traverses 27, and of the user's distance 28 to the destination DEST.

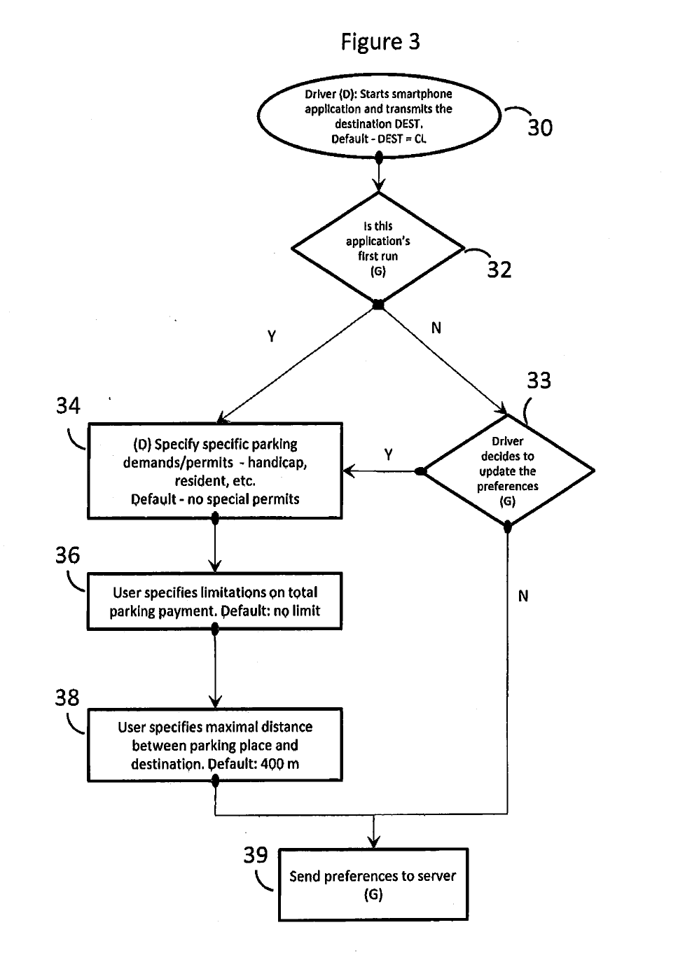

FIG. 3 schematically illustrates how the proposed system can be initiated from a user's mobile device. The user (driver) is schematically marked with D. Blocks of the flowchart schematically show steps of the method's initiation, which are preferably implemented by software means provided in the proposed mobile application. Let the driver's mobile device is G, and a server is S.

Block 30: D starts a suitable mobile application of a proposed technique (say, a smartphone application). The step usually comprises indication of the destination PEST which is transmitted to the server (S). In case the destination is not transmitted, the default setting may be that the user is searching for parking within the vicinity of the current location. User's parking preferences, in case they are different from some default preferences, are established, and user's current location CL is provided by the equipment (smartphone's) GPS receiver.

Block 32 checks (by software means at the mobile device G) whether it is the application's first launch.

If it is the first run of the program (or if the driver's preferences changed from the last trip and are to be updated by D), Block 33 of the algorithm will continue the process via Blocks 34, 36, 38.

Block 34 supposes that D will introduce specific parking permits, such as a permit to park at places for handicapped drivers, a citizen's/resident's permit. The default is “no special permits”.

Blocks 36, 38 comprise means for introducing D's parking preferences: for example, on the maximal parking price and on the walk distance/walk time to the DEST. Default maximal price maybe, for example $3/hour and default walk distance can be 400 m/7 minutes. Block 39 is an optional software/hardware unit of the mobile device, responsible for transmitting parking preferences of D and changes thereof from the user's mobile device (G) to the server (S). If the application was launched in the past, the previous parking preferences may be exploited (see Block 33); in this case the preferences may be transmitted to the server S in the form previously stored in the mobile device.

The user may create alternative sets of preferences for the same trip. In this case the flow chart of FIG. 3 will operate accordingly.

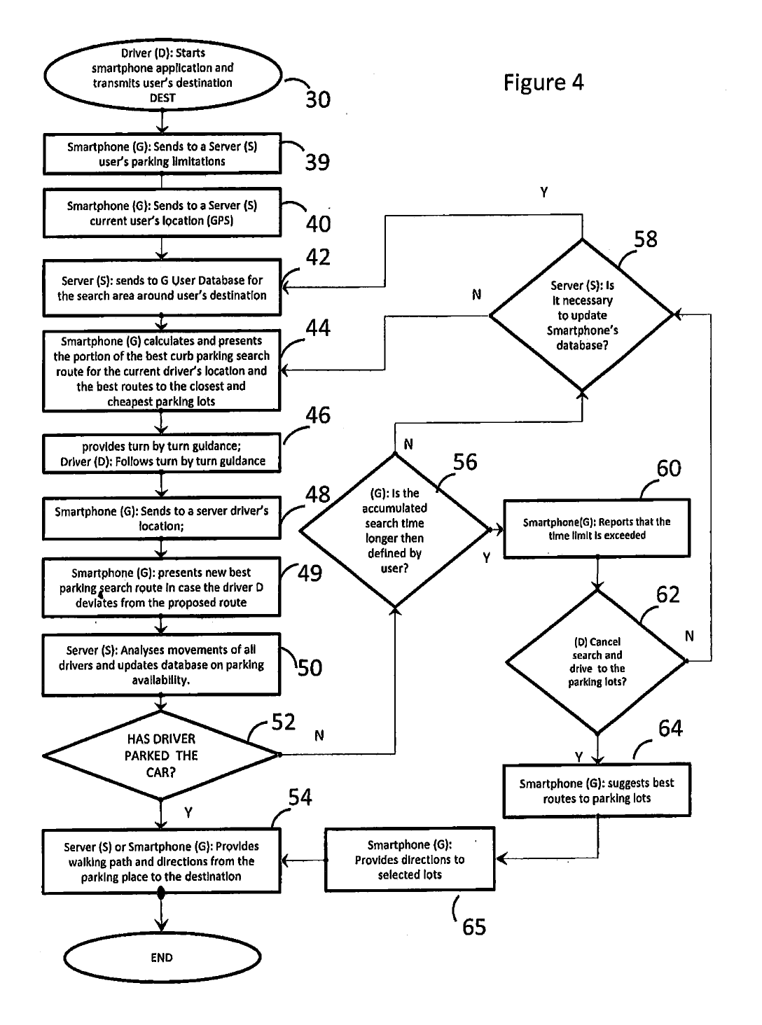

FIG. 4 illustrates the main steps of the proposed navigation procedure. The procedure starts with the previously described steps/blocks 30 and 39.

Block 40 is responsible for obtaining the user car's current location (CL) and transmitting it as input data to the server (S). The current location data is continuously produced in cooperation with a OPS sensor of the user's mobile device.

Block 42 illustrates one of the new steps proposed by the Inventors. Server S transmits to the user's mobile device (G), that contains the information from the Server Data Base that is necessary for the parking search within the user's search area, namely the currently available information about all possible routes and all possible parking places in the parking area of interest (i.e., in the area defined by a radius selected by the user around the DEST). This information may be, for example, in the form of a User parking search Database, formed for that specific client D.

The Server S may be adapted to calculate best parking search routes for all drivers D in the urban area. However, FIG. 4 shows a more advanced, decentralized version of the method, according to which the parking search is performed by mobile devices of the users, based on the respective User parking search Databases received from the Server. In any version of the method, the best parking search routes that are determined according to specific sets/combinations of the driver's parking preferences will be finally presented at each of the mobile devices.

Block 44 may comprise a search engine of the mobile device G, and be capable of providing at least one search in the User Database (received from 5) in order to define at least one best parking route/path. The best parking routes presented at the mobile device G will be always optimized for the input data (DEST, CL) and according to the driver's parking preferences. Optionally, block 44 also calculates routes from the CL to a) the closest to the DEST parking lot, and b) the cheapest parking lot in or beyond the parking area. Other options of additional parking routes are possible.

Block 46 is responsible for providing the “turn by turn” guidance to the driver D by the mobile device G. It is supposed that the driver D follows the provided turn by turn guidance. If not, the best parking route(s) are recalculated starting from the new CL, (see block 48).

The Server stores the mentioned User Databases and continuously updates its parking information in the main Database and, if necessary, in the User Databases. For example, the Server may analyze the drivers' behavior during their parking search, and based on that, may update the User Database (in this example, the Server Database is always up-to-date).

Possible ways of updating the Server (S) and the user's mobile devices (G) will be discussed in more details with reference to boxes 48-58.

Block 48 is responsible for sensing the drivers' movement, and to transmitting the information to the Server, so as to recalculate the routes if and when necessary.

Block 49 is responsible for recalculating the best search route(s) in case the driver deviates from the proposed search route.

Block 50 describes operations performed in the server (S), namely—receiving updates about drivers' current locations, analysis of the drivers' movements, updating the Server Database on current parking availability by using information received from the users who drive along the proposed best parking routes in real time, and updating the best parking routes in case these routes are presently stored at the Server. See also block 52.

Block 52 updates the Server, whether the driver has parked. The check may be performed periodically, for example by analyzing user's GPS information or by an explicit user's action.

If the car is finally parked, the system will be capable to show the user the preferred walking path from the parking place to the destination DEST (Block 54).

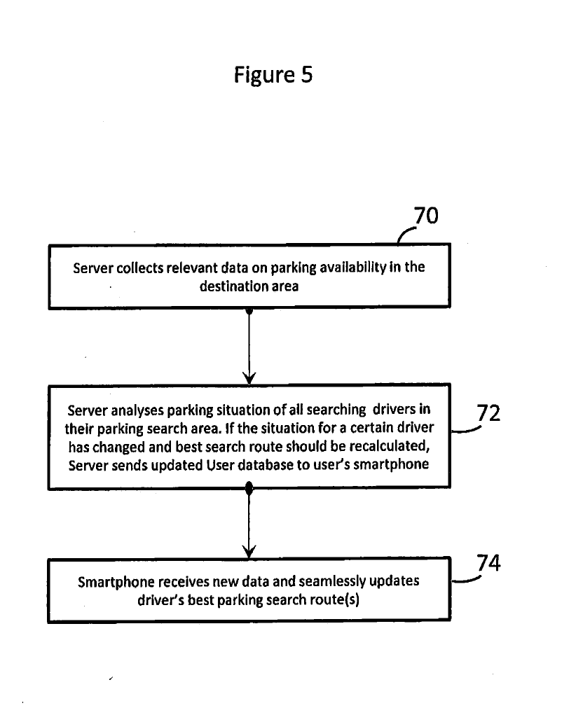

If any case, updates about parking availability of a specific road link may be introduced into the Server and User Databases (the latter also, transmitted to the mobile device G)—see Block 58 and also FIG. 5.

If the parking search continues, the search time is compared with the user-defined maximal search time (Block 56), and the mentioned updates are made to the Server Database and to the User Database to facilitate best possible search further (Block 58). If the time limit set by the user expires, the user is warned about that and advised to navigate to a parking lot (Block 62).

If the driver D follows the advice, cancels the curb search and decides to park at a parking lot (Block 62), he/she will be provided with suggestions (Block 64) and directions to the selected parking lot (Block 65). If the driver does not wish to cancel the search, updates of the Database will be performed (Block 58) before the search for a curb parking place continues.

FIG. 5 presents an exemplary flowchart which specifies how the Server of the inventive system may update the parking availability information. Actually, FIG. 5 is one option of preparing and performing the function of Block 58 shown in FIG. 4.

Block 70 shows that Server may continuously collect data on the real time parking availability all over the city and analyses parking situation in a parking area around specific destinations of every searching driver. Such data may be collected in various ways, for example from a vehicle while being navigated in the parking area by the proposed system. For instance, the fact that the vehicle is parked may serve as a confirmation of the best/optimized parking route proposed to the user, and as confirmation of the parking availability of the specific road segment where the vehicle was parked. On the contrary, if the vehicle passes a “recommended” road segment in the parking area near its DEST and is not parked, the current parking availability of that specific segment may be temporarily updated to be 0. (Consequently, the best parking route/s of that and/or other user may be updated, see blocks 72, 74).

Block 72 shows an optional functionality of the Server to perform continuous updates of the User Databases about curb and off-street parking places in the driver's search areas for all drivers being in communication with the Server. The Server may continuously recalculate best parking routes and send them to drivers. This function can be also performed by the user's smartphone based on the updated User Database transmitted by the Server.

Block 74 shows that the mobile devices, upon receiving the update from the Server, will update the best parking search route(s) presented to the driver.

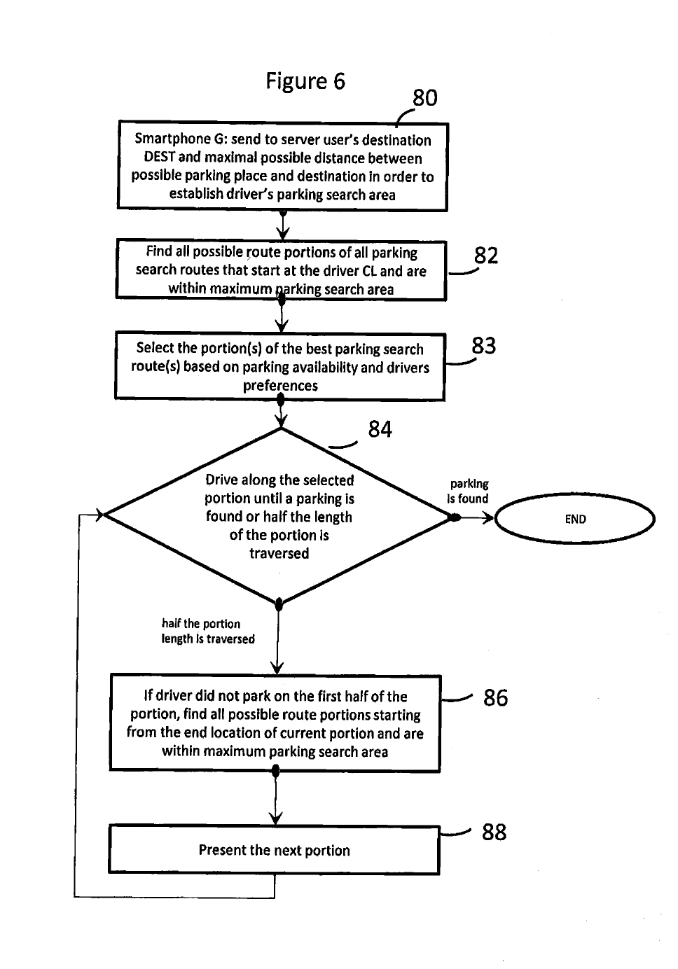

FIG. 6 is a flow chart explaining one optional way of calculating the endless continuous best parking search route for a vehicle driving in a specific parking area having the center at a DEST, given a specific current location CL. The example of FIG. 6 illustrates that the best parking search route is endless (unlimited in its length) and may be gradually composed from newly portions calculated in real time.

As already mentioned before, the calculation of the best parking search route may be fully performed at the Server S, which may determine a current best parking path by applying a specific set of driver's parking preferences. Alternatively, the calculation may be performed at the Server only partially, so that a User Database is formed at the Server for a specific user based on the information on user's destination DEST and maximal distance between the possible parking place and destination, and then the calculation of the portions of the best parking route is performed at the user's mobile device where specific parking preferences of the driver are applied.

Blocks 80-88 are applicable to the both above cases.
Block 80 Establishes the vehicle's location CL and the driver's destination PEST and maximal distance between possible parking place and destination DEST in order to establish driver's parking search area;
Block 82 determines all possible portions of all parking search routes within the parking area that start from the CL, are not longer than a predetermined length and satisfy user's set(s) of preferences.
Block 83 Selects the portion which accumulates the maximal number of expected vacant parking places PP; that portion will constitute the current portion of the best parking route(s).
Block 84 guides the vehicle along the current route portion until the vehicle is parked or until half of the current route portion is traversed.
Block 86 is responsible for calculating a new portion of the best parking route for the vehicle, to be used in case the vehicle will reach the end of the current route portion without parking. The calculation is performed similarly to that described in Blocks 80-82.
Block 88 presents the new portion of the best parking search route calculated at Block 86: if the vehicle arrives to the end of the current route portion (and is not parked yet), it will continue the search along the new portion.

Based on the above-described examples of the new proposed technology, one may realize that the novel technique preliminarily determines the expected number of vacant PPs (ENVP) on each road segment. The estimate may be based upon earlier observations of PPs availability along the street segments at the same time of a day, day of the week, and period of a year. Initial estimates of the number and location of the available curb and off-street PPs may come from the layers of urban GIS and field surveys. The surveys are conducted in a given area or in areas with the similar parking conditions. These conditions include parking permission in the area, car ownership rate of the area's residents, residential demand for parking and location, size and type of activities of the educational, business and commercial units and leisure facilities, all attracting visitors who do not reside in the area.

The parking availability information, stored by road segments, is further presented to a specific user as the best parking search route calculated for that specific user.

The initial information of the parking supply may be instantaneously updated based on a) external sources, b) the accumulated information on the outcomes of parking search of the drivers who have exploited the facility in this area in the past and c) the real-time information received from the drivers who currently search for parking in this area. The updates usually relate to specific road segments, and thus are used to update information on the relevant segments in the Server and Users Databases. The proposed novel technique is therefore adapted to build the best parking search routes in the area, for every new driver arriving to the area by using the most updated information that is available.

The facility may ensure that the driver's destination, current location and the best and additional parking routes are presented on a display, so that the driver can manually manipulate with them.

The proposed facility may comprise displaying several best parking routes each providing the maximal possible number of parking place each satisfying one of the alternative sets of user's preferences. In case the probability to find a PP when driving along a specific best parking search route is very low or zero, the facility may report this to the driver and may suggest to change the search preferences. Each ready (calculated or displayed) parking route is preferably accompanied by the data on expected search time, walking time to destination and total parking fees.

The facility may further comprise estimation of the expected search time, walking time to destination and total parking fees in case the facility is not employed and the driver would decide to search the PP on her/his own.

Further, the facility may provide that for each displayed parking route, several road segments ahead are presented, while each of the routes is instantaneously updated, in respect to the driver's advance and based on the real-time information on the parking search of the user and the other drivers that use the facility in the area. In this manner, the facility always provides to the driver several next segments for each of the displayed parking routes.

The facility thus will be capable either to provide the user with a group of the most efficient parking routes, each satisfying a given set of criteria (parking preferences), or will be capable to report to the user that his/her preferences cannot be satisfied. Taken together, the group of alternative parking routes covers all best parking options in the area and makes the driver's parking search maximally efficient.

It should be appreciated that while the invention has been described with reference to specific examples and drawings, other versions of the method may be proposed which should be considered part of the invention whenever defined by the claims which follow.

That which is claimed is:

1. A method of providing guidance to a user, while driving and seeking a vacant parking place, by presenting to the user a best parking route wandering within a parking area determined around the user's destination, the method comprising:
calculating and presenting to the user, in real time, portion by portion of said best parking route, wherein each newly presented portion of said best parking route
is calculated based on the user's current location and based on information on parking availability within the parking area;
is characterized by a maximal number of vacant curb parking places expected on that portion according to said information;
satisfies a set of parking preferences stated by the user,
thereby ensuring the maximal expected number of the vacant curb parking places along the best parking route wandering within the parking area up to either the user finds a vacant curb parking place according to the set of parking preferences, or the parking preferences are changed.

2. The method according to claim 1, wherein the method further comprises updating said information in real time, performed by the user and other users utilizing said guidance.

3. The method according to claim 1, further comprising:
simultaneously presenting to the user one or more additional parking routes comprising at least one of the following:
an alternative best parking route satisfying an alternative set of parking preferences of the user;
a parking route to a parking lot being closest to the user's destination;
a parking route to a parking lot being the cheapest in the parking area or beyond it; and
a parking route to a parking lot arbitrarily chosen by the user in the parking area or beyond it.

4. The method according to claim 3, wherein at least one of said additional parking routes to the closest, the cheapest and the selected parking is optimized to provide the maximal possible expected number of vacant curb parking places there-along.

5. The method according to claim 1, comprising:
calculating all possible route portions within the parking area, starting from the user's vehicle current location CL and being no longer than a predetermined length;
selecting, from all said possible route portions, said portion of the best parking route; and
in case the user's vehicle has not parked on its way to the selected best parking route portion's end point, presenting to the user a next portion of the best parking route calculated as starting from said end point considered a new CL, thereby forming a gradually extendable best parking route.

6. The method according to claim 5, wherein calculation of each newly presented portion of said best parking route comprises:
calculating all possible route portions within the parking area, starting from the user's vehicle current location CL and being no longer than the predetermined length; and
selecting, from all said possible route portions, a new portion of the best parking route for presenting to the user.

7. The method according to claim 1, comprising preliminary steps of:
providing a Server and providing the user with a mobile device;
forming a Server Database DB storing information on parking availability within an urban area including said parking area,
the method further comprising:
establishing bidirectional real time communication between the Server and the user's mobile device;
providing said Server with information from said mobile device on the user's destination DEST, user's vehicle current location CL, a set of the user's parking preferences;
providing the mobile device with a best parking route, determined using said DB, according to said set of the user's parking preferences and being maximized regarding a number of expected vacant curb parking places there-along; and
updating said Server by the user in real time.

8. The method according to claim 1, wherein said set of parking preferences comprises one or more of the following privileges and/or limitations:
resident/visitor of the city;
specific parking permit;
conventional driver/handicapped driver entitled for special parking places;
private car/van/ truck/ bus etc.;
maximal walking distance/walking time from the parking place to destination;
maximal price of the curb/off-street parking place;
maximal parking search time available to the driver; and
latest time of arrival to the destination's entrance.

9. The method according to claim 3, further comprising displaying different simultaneously presented route portions, route segments and/or parking routes using different colors or patterns.

10. The method according to claim 1, further comprising informing the user about parking restrictions for each side of the road segment being currently passed by the user.

11. method according to claim 1, further comprising periodically or continuously updating said best parking route presented to the user.

12. The method according to claim 1, further comprising estimating, for said best parking route, one or more of the following parameters: expected parking search time, total parking fees during an expected period of parking, distance between the expected parking place and/or the walk time from the expected parking place to a destination, a probability of failure to find a parking place during the maximal available parking search time.

13. The method according to claim 1, accounting for the best parking routes suggested to different users of said guidance and preventing potential overlap of the best parking routes of two or more said different users.

14. The method according to claim 1, comprising grouping different users of said guidance into at least two different groups, and guiding users of the different groups according to different policies.

15. A system for implementing the method according to claim 1.

16. A system for providing guidance to a user driving a user's vehicle and searching for a vacant parking place in a parking area selected around the user's destination DEST, the system comprising:
a Server;
a Server Database DB for storing information on availability of vacant parking places in an urban area comprising said parking area, and for determining parking routes in the urban area, the DB being in real time communication with the Server or being a part of the Server; and
a mobile device located in the user's vehicle, equipped with a GPS sensor and capable of establishing real time bidirectional communication with the Server, wherein the Server being operative:
to communicate with said mobile device for receiving therefrom information on the user's destination DEST, user's vehicle current location CL, a set of the user's parking preferences;
to communicate with the mobile device for providing it with a best parking route, determined using said DB, according to said set of the user's parking preferences and being maximized regarding a number of expected vacant curb parking places there-along; and
to receive updates from said mobile device at least on the user's vehicle current location CL, the parking preferences in real time, and update said DB accordingly.

17. The system according to claim 16, wherein the Server being further operative:
to form a User Database UDB, using said DB and based on the information received from the user; said User Database being suitable for determining parking routes in the parking area;
to provide to said mobile device either:
a best parking route, determined according to said set of the user's parking preferences and being maximized regarding a number of expected vacant curb parking places there-along, calculated by the Server using said User Database, or
the User Database for calculating said best parking route at the mobile device; and
to receive updates from said mobile device on the user's parking search results and update said DB and UDB accordingly.

18. The system according to claim 16, further comprising one or more sources of information updated periodically or in real time on availability of parking places in said urban area, the sources being in communication with the Server to update the currently existing information in the Database.

19. The system according to claim 16, comprising at least one additional mobile device in bidirectional real time communication with the Server, wherein the Server is capable to form for all said mobile devices respective UDBs.

20. A software product, comprising computer implementable instructions and/or data for carrying out the method according to claim 1, stored on an appropriate computer readable storage medium so that the software is capable of enabling operations of said method when used in a computer system.
